(19) United States
(12) Patent Application Publication
(10) Pub. No.: US 2021/0350637 A1
(43) Pub. Date: Nov. 11, 2021

(54) DEVICE AND SOFTWARE ENABLING VEHICLE-TO-EVERYTHING CAPABILITIES IN ON-BOARD DIAGNOSTICS BASED VEHICLES AND A PLATFORM ACCESSING AND MANAGING DATA OF NEARBY VEHICLE-TO-EVERYTHING CAPABLE VEHICLES

(71) Applicant: Jorge Estrada, Huntington Park, CA (US)

(72) Inventor: Jorge Estrada, Huntington Park, CA (US)

(21) Appl. No.: 16/868,557

(22) Filed: May 7, 2020

(51) Int. Cl. G07C 5/08; H04W 4/44; H04W 4/46

(52) U.S. Cl. CPC G07C 5/0808; H04W 4/46; H04W 4/44; G07C 5/0825

(57) ABSTRACT

A device and software, which the device contains, allows a broad range of vehicles to connect to and transfer vehicle data between each of the vehicles, regardless of the make and manufacturer of the vehicles. The device comprises computing devices, software and software controls, modules and sensors such as a Wireless Vehicle-to-Infrastructure (C-V2X) Module, an Inertial Measurement Unit, a Global Navigation Satellite System (GNSS)/Global Positioning System (GPS) Module, a Memory Storage Unit, a wireless communication module, an Inertial Module Unit, a wireless triangulation module, and a plurality of antennas and a separate OBD-II port adapter. The graphical user interface of the device displays information from other vehicles collected through the device and accessed through the devices available software Application Programming Interface (API).

### TECHNICAL FIELD

The present disclosure relates to a device and software, which the device contains, that allows a broad range of vehicles to connect to and transfer vehicle data between each of the vehicles, regardless of the make and manufacturer of the vehicles.

### BACKGROUND

The current methods of providing Vehicle-to-Vehicle (V2V) and Vehicle-to-Infrastructure (V2X) require proprietary and costly telecommunication units to be built directly into a vehicle. V2X is meant to improve vehicle safety systems and allow smart and autonomous vehicles to benefit from increased data from nearby vehicles. However, current units developed from different manufacturers do not work or communicate with each other and older vehicles currently cannot be fitted with V2X technology. Both of these issues hinder the capabilities of V2X technology.

The more vehicles capable of communicating with each other through V2X the more useful the V2X technology becomes. Therefore, the solution to the above problems is to create a small, portable and communications and power efficient consumer and manufacturer friendly V2X telecommunications device that can be connected to nearly any vehicle (any vehicle that contains an On-Board Diagnostics (OBD-II) port) on the road today and in the future. Since the device is portable and connects to the On-Board Diagnostics (OBD-II) port of a vehicle, there is no need to embed the device directly into the vehicle during the vehicle's manufacturing process. The device instead allows V2X capabilities to be installed after a vehicle has been manufactured. This device and the software which the device contains will allow a broad range of vehicles to connect to and transfer vehicle data to each other regardless of the make and manufacturer of the vehicle. This enables any (i.e. especially newer smart and autonomous vehicles) smart and autonomous vehicle to take advantage of data from nearly any vehicle the smart and autonomous vehicle comes into proximity of the with which allows the manufacturers of these smart and autonomous vehicles to take advantage of V2X technology and implement V2X based safety solutions. Therefore, the device and the software of the device allow V2X communications between nearly any make and model vehicle. Since the device supports V2X, the device will also be capable of connecting to other V2X capable devices and to other devices and apparatus such as highway infrastructure or similar and equivalent devices, structures or apparatus. The software provided in the device will allow manufacturers to pick and choose what data they need from the V2X capable vehicles they are connected to and create external applications that can connect to and add features to their V2X capable vehicles. Furthermore, the software within the device allows third parties to manage the data being received from their V2X capable device and one such external application allows mapping of local V2X vehicle networks to improve safety feature testing and the testing of smart and autonomous vehicles and their interactions between non-smart and non-autonomous V2X capable vehicles.

### SUMMARY

An object of the present disclosure is to provide a device and software that allows a broad range of vehicles to connect to and transfer vehicle data between each of the vehicles, regardless of the make and manufacturer of the vehicles.

The device is a small, portable and communications and power efficient consumer and manufacturer friendly Vehicle-to-Infrastructure (V2X) telecommunications device that can be connected to nearly any vehicle (any vehicle that contains an On-Board Diagnostics (OBD-II) port) on the road today and in the future. This device and the software, which the device contains, will allow a broad range of vehicles to connect to and transfer vehicle data to each of the vehicles regardless of the make and manufacturer of the vehicle. Since the device supports V2X, the device will also be capable of connecting to other V2X capable devices and to other devices and apparatus such as highway infrastructure or similar and equivalent devices, structures or apparatus. The software provided in the device will allow manufacturers to pick and choose what data they need from the V2X capable vehicles they are connected to and create external applications that can connect to and add features to their V2X capable vehicles. Furthermore, the software within the device allows third parties to manage the data being received from their V2X capable device and an external application allows mapping of local V2X vehicle networks to improve safety feature testing and the testing of smart and autonomous vehicles and their interactions between non-smart and non-autonomous V2X capable vehicles.

The operation, use and function of the device are provided in the details below.

The device is plugged into the OBD-II port of a compatible vehicle. The device is registered to a vehicle by using a unique identification number such as the vehicles vehicle identification number (VIN), license number or other similar or equivalent number or unique identifier. The registration is done through a mapping/management software provided in the device. When the vehicle is turned/powered on, the device will begin running the software within the device. The software will parse through data from the vehicle through the OBD-II port; store vehicle data onto a memory storage unit on the device; create and store data created from units and/or sensors on the device such as inertial measurement units, cellular connectivity units, global positioning units, and/or any extra sensors attached to the device; connect to external applications as applicable; and search for nearby V2X capable devices. Examples of the external applications can be software that maps a local network of interconnected V2X capable devices or software created by third parties using an Application Programming Interface (API)/Software Platform. A local network can represent all V2X capable devices that are connected to each other and are within the wireless range of the device the external application is running on. Examples of V2X capable devices can be vehicles with the device (i.e. the device being plugged into the OBD-II port of a compatible vehicle) plugged into the vehicle or other manufacturers telecommunication devices that support V2X and the software from this device.

Once a V2X capable device is found/located by the wirelessly communication of the device, the device will attempt to connect to this V2X capable device wirelessly. This search and connection process repeat until the vehicle is shut/turned off. All V2X capable devices that the device is wirelessly connected to will have local vehicle data (data generated from the device connected directly to the vehicle) transferred to these V2X capable devices. The device will in turn receive data from all the wirelessly connected V2X capable devices.

The software on the device can be expanded on to manage the data received from any connected V2X capable device through an Application Programming Interface (API)/Software Platform. The software on the device can connect to the external applications using the API/Software Platform. Secondary software running on an external device such as a mobile phone, a desktop or laptop computer, a tablet, or any other similar or equivalent device, will allow a user to view and map the local network of interconnected V2X capable vehicles.

The device can then be mounted onto the dashboard or any surface or part of a vehicle and provide the V2X capabilities.

The device can be built into an external housing to be attached to a roof of a vehicle and use inertial measurement units to calculate vehicle data.

In another embodiment, the device can be built without a dependence to the On-board Diagnostics Port of a vehicle and the device uses inertial measurement units to calculate vehicle data.

### BRIEF DESCRIPTION OF THE DRAWINGS

In order to more clearly illustrate the embodiments of the present disclosure, a brief description of the drawings is given below. The following drawings are only illustrative of some of the embodiments of the present disclosure and for a person of ordinary skill in the art, other drawings or embodiments may be obtained from these drawings without inventive effort.

FIG. 1 is a schematic diagram of the invention illustrating a device wirelessly connecting to Vehicle-to-Infrastructure (V2X) capable vehicles.

FIG. 2 is a schematic view of an On-Board Diagnostics (OBD-II) port adapter and the device comprising a processor and software control, a Cellular/Wireless Vehicle-to-Infrastructure (C-V2X) Module, an Inertial Measurement Unit, a Global Navigation Satellite System (GNSS)/Global Positioning System (GPS) Module, a Memory Storage Unit and antennas.

FIG. 3 is a diagram of the connections and functions between the device and the On-Board Diagnostics of a Vehicle-to-Everything (V2X) capable vehicle.

FIG. 4 is a top perspective view of the housing of the On-Board Diagnostics device and components of the On-Board Diagnostics device.

FIG. 5 is a side view of the housing of the On-Board Diagnostics device and components of the On-Board Diagnostics device.

FIG. 6 is a top, side perspective view of the housing and the On-Board Diagnostics device and components of the On-Board Diagnostics device.

### DETAILED DESCRIPTION

The technical solutions of the present disclosure will be clearly and completely described below with reference to the drawings. The embodiments described are only some of the embodiments of the present disclosure, rather than all of the embodiments. All other embodiments that are obtained by a person of ordinary skill in the art on the basis of the embodiments of the present disclosure without inventive effort shall be covered by the protective scope of the present disclosure.

In the description of the present disclosure, it is to be noted that the orientational or positional relation denoted by the terms such as “center”, “upper”, “lower”, “left”, “right”, “vertical”, “horizontal”, “inner” and “outer” is based on the orientation or position relationship indicated by the figures, which only serves to facilitate describing the present disclosure and simplify the description, rather than indicating or suggesting that the device or element referred to must have a particular orientation, or is constructed or operated in a particular orientation, and therefore cannot be construed as a limitation on the present disclosure. In addition, the terms “first”, “second” and “third” merely serve the purpose of description and should not be understood as an indication or implication of relative importance.

In the description of the present disclosure, it should be noted that unless otherwise explicitly specified and defined, the terms “install”, “link” and “connect” shall be understood in the broadest sense, which may, for example, refer to fixed connection, detachable connection or integral connection; may refer to mechanical connection or electrical connection; may refer to direct connection or indirect connection by means of an intermediate medium; and may refer to communication between two elements. A person of ordinary skill in the art would understand the specific meaning of the terms in the present disclosure according to specific situations.

The present disclosure and invention of are described in detail below in reference to the figures.

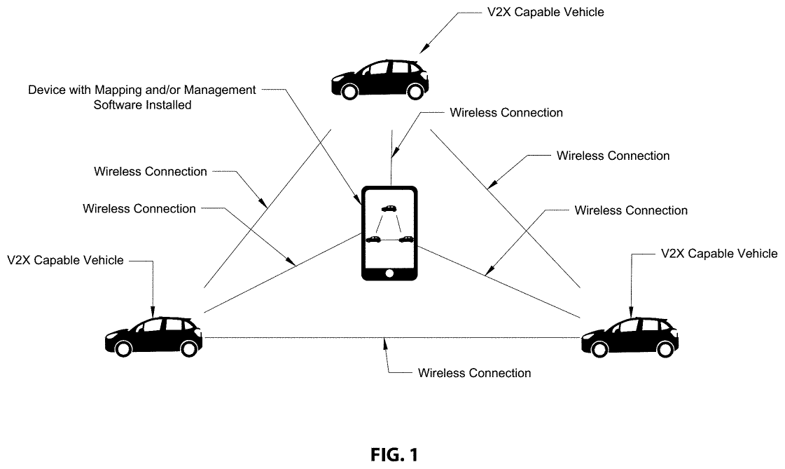

FIGS. 1-6 illustrates the present invention being a device and software that allows a broad range of vehicles to connect to and transfer vehicle data between each of the vehicles, regardless of the make and manufacturer of the vehicles.

FIG. 1 shows vehicles that have a device installed therein. An external device is illustrated in the center of FIG. 1. The external device comprises a graphical user interface (GUI), such as a screen, and contains mapping and/or management software in the external device. The device installed in the vehicles is a small, portable and communications and power efficient consumer and manufacturer friendly Vehicle-to-Infrastructure (V2X) telecommunications device that can be connected to nearly any vehicle (any vehicle that contains an On-Board Diagnostics (OBD-II) port) on the road today and in the future. The installed device and the software, which the device contains, will allow a broad range of vehicles to connect to and transfer vehicle data to each of the vehicles regardless of the make and manufacturer of the vehicle. Since the device supports V2X, the device will also be capable of connecting to other V2X capable devices and to other devices and apparatus such as highway infrastructure or similar and equivalent devices, structures or apparatus. The software provided in the device will allow manufacturers to pick and choose what data they need from the V2X capable vehicles they are connected to and create external applications that can connect to and add features to their V2X capable vehicles. Furthermore, the software within the device allows third parties to manage the data being received from their V2X capable device and an external application allows mapping of local V2X vehicle networks to improve safety feature testing and the testing of smart and autonomous vehicles and their interactions between non-smart and non-autonomous V2X capable vehicles.

The details, operation, use and function of the device are provided in the details below.

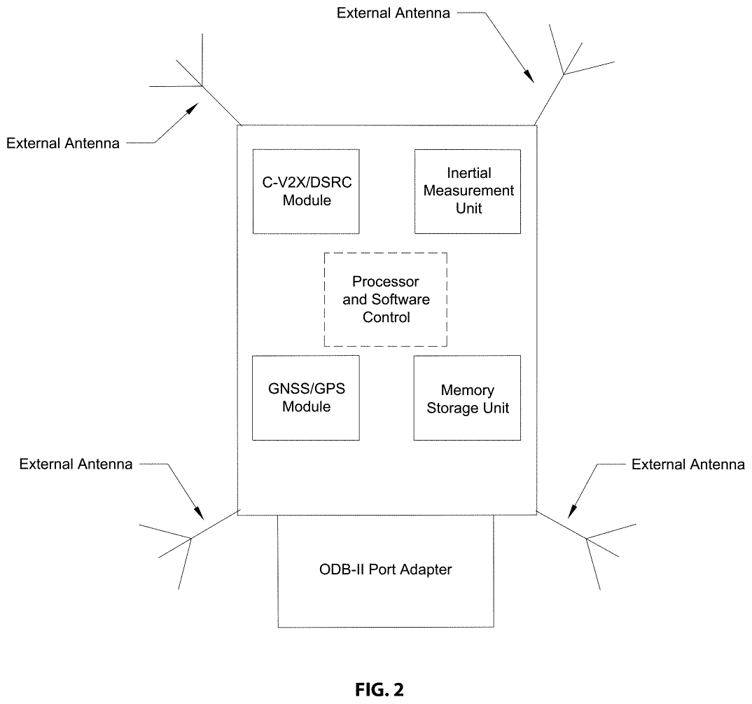

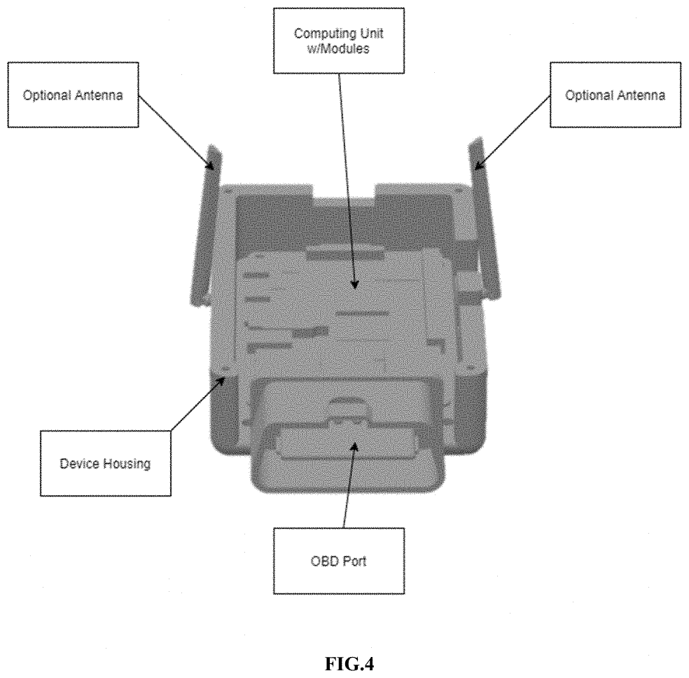

FIG. 2 is a general overview of the device. As shown in FIG. 2, and FIG. 4 through FIG. 6, the device comprises a graphical user interface (GUI), such as a screen, computing devices such as chips and processors, software and software controls, modules and sensors such as a Raspberry Pi™ 4, a Cellular/Wireless Vehicle-to-Infrastructure (C-V2X) Module, an Inertial Measurement Unit, a Global Navigation Satellite System (GNSS)/Global Positioning System (GPS) Module, a Memory Storage Unit, a wireless communication module, an Inertial Module Unit, a wireless triangulation module, and a Bluetooth™ module and a plurality of antennas. The OBD-II port is directly connected to the device that houses the computing devices/units and antennas. The device's components are directly connected to each other and do not need Bluetooth to communicate. The device can connect to external applications that contain a screen and then display data. The graphical user interface of the device displays information from other vehicle(s) collected through the device and accessed through the devices available software Application Programming Interface (API).

The device is plugged into the OBD-II port of a compatible vehicle. The device is registered to a vehicle by using a unique identification number such as the vehicle's vehicle identification number (VIN), license number or other similar or equivalent number or unique identifier. The registration is done through an external application. When the vehicle is turned/powered on, the device will begin running the software within the device. The software will parse through data from the vehicle through the OBD-II port; store vehicle data onto a memory storage unit on the device; create and store data created from units and/or sensors on the device such as inertial measurement units, cellular connectivity units, global positioning units, and/or any extra sensors attached to the device; connect to external applications as applicable; and search for nearby V2X capable devices. Examples of the external applications can be software that maps a local network of interconnected V2X capable devices or software created by third parties using an Application Programming Interface (API)/Software Platform. A local network can represent all V2X capable devices that are connected to each other and are within the wireless range of the device the external application is running on. Examples of V2X capable devices can be vehicles with the device (i.e. the device being plugged into the OBD-II port of a compatible vehicle) plugged into the vehicle or other manufacturers telecommunication devices that support V2X and the software from this device.

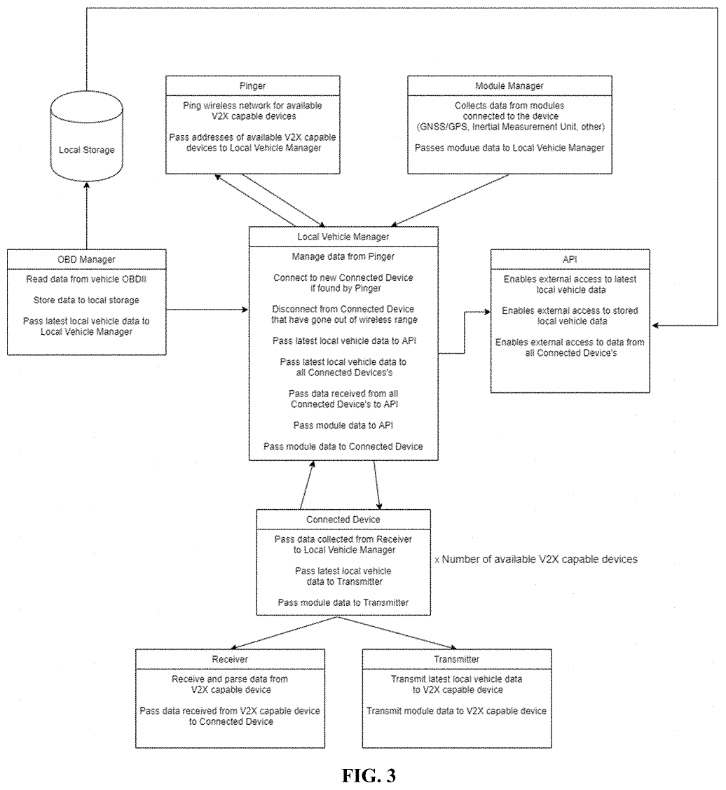

As shown in FIG. 3, the device pings for vehicles and devices that are V2X capable and are within range of the device. The range is based on the wireless communication module that can be based on IEEE 802.11p/DSRC. Once the device is connected to any vehicle and/or other device(s) that has been successfully pinged the device can transmit local vehicle data to these other devices; receive data from the connected vehicles and disconnects from the connected vehicle(s) if out the vehicle(s) are out of range. More specifically, once a V2X capable device is found/located by the wirelessly communication of the device, the device will attempt to connect to this V2X capable device wirelessly. This search and connection process repeat until the vehicle is shut/turned off. All V2X capable devices that the device is wirelessly connected to will have local vehicle data (data generated from the device connected directly to the vehicle) transferred to these V2X capable devices. The device will in turn receive data from all the wirelessly connected V2X capable devices. The collection of data from a local vehicle (i.e. a vehicle the device is directly connected to) is through the OBD-II port.

The software on the device can be expanded on to manage the data received from any connected V2X capable device through an Application Programming Interface (API)/Software Platform. The software on the device can connect to the external applications using the API/Software Platform. Secondary software running on an external device such as a mobile phone, a desktop or laptop computer, a tablet, or any other similar or equivalent device, will allow a user to view and map the local network of interconnected V2X capable vehicles. The API functions and operates to allow third parties to integrate the device and its accompanying software platform into their own vehicle platforms without needing to modify hardware; allow third parties to manage data that is coming in through the device; allow third parties to send custom commands to a connected vehicle's OBD-II and receive raw responses; and allow third parties to create accompanying web/phone applications (i.e. apps) that can access and manage local and connected vehicle data. The web/phone app functions to allow vehicle owners to view what data is being sent and received from their vehicle.

As shown in FIG. 3, an OBD Manager reads data from a vehicle's OBD-II; stores data into a local storage device and passes the latest local vehicle data to a local vehicle manager. The OBD Manager is at least in communication with the local storage device and the local vehicle manager. A Pinger pings a wireless network for available V2X capable devices and passes addresses of available V2X capable devices to the local vehicle manager. The Pinger is at least in communication with the local storage manager. The module manager collects data from various modules of the device and is connected to the device. The module manager passes various module data to the local vehicle manager and is at least in communication with the local storage manager. The API enables external access to the latest local vehicle data; enables external access to stored local vehicle data and enables external access to data from all connected devices. The API is at least in communication with the local storage device and the local vehicle manager. The local vehicle manager manages data from the Pinger; connects to newly connected device(s) if found by the Pinger; disconnects from the connected device(s) which have gone out of wireless range; passes the latest local vehicle data to the API; passes the latest local vehicle data to all connected devices; passes data received from all connected devices to the API; passes various module data to the API and passes various module to the connected device. The local vehicle manager is at least in communication with the Pinger, the module manager, the API, the OBD manager and the connected device(s). The connected device(s) pass data collected from the receiver to the local vehicle manager; passes the latest local vehicle data to a transmitter and passes various module data to the transmitter. The connected device(s) is/are at least in communication with the receiver, the transmitter and the local vehicle manager. The receiver receives and parses data from V2X capable device(s) and passes data received from V2X capable device(s) to connected device(s). The receiver is at least in communication with the connected device(s) and the transmitter. The transmitter transmits local vehicle data to V2X capable device(s) and transmits various module data to V2X capable device(s). The transmitter is at least in communication with the connected device(s) and the receiver.

FIG. 4 illustrates the housing of the device and the computing unit(s) with modules and an On-Board Diagnostics port. The housing can optionally comprise an antenna or a plurality of antennas.

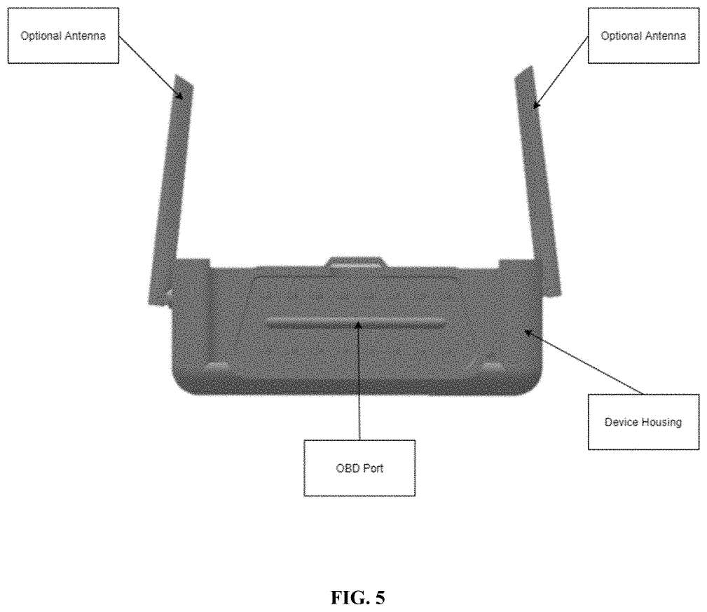

FIG. 5 illustrates the housing of the device and the On-Board Diagnostics port. The housing can optionally comprise an antenna or a plurality of antennas.

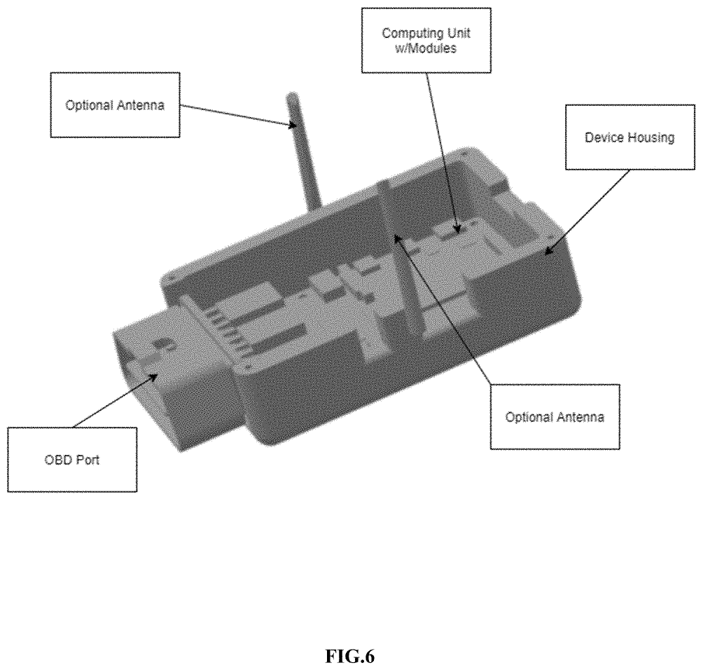

FIG. 6 illustrates the housing of the device and the computing unit(s) with modules and an On-Board Diagnostics port. The housing can optionally comprise a antenna or a plurality of antennas.

The device can then be mounted onto the dashboard or any surface or part of a vehicle and provide the V2X capabilities.

The device can be built into an external housing to be attached to a roof of a vehicle and use inertial measurement units to calculate vehicle data.

In another embodiment, the device can be built without a dependence to the On-board Diagnostics Port of a vehicle and the device uses inertial measurement units to calculate vehicle data.

The device does not directly provide a user interface to the owner of the local vehicle; directly diagnose traffic conditions through collected data of both local and connected vehicles; directly manage or control vehicles the device is installed in or connected to; directly provide autonomous vehicle functionality; connect to a vehicle management server; and the device does not include cameras or LIDAR.

Finally, it should be noted that the above embodiments are only used to illustrate the technical aspects of the present disclosure, rather than limit the embodiments. Although the present disclosure has been described in detail with reference to the foregoing embodiments, it should be understood by a person of ordinary skill in the art that the technical aspects described in the embodiments can still be modified or equivalent substitutions can be made to some or all of the technical features and the modifications or substitutions would not change the substance of the scope of the embodiments of the present disclosure.

What is claimed is:

1. A device comprising a computing device, software and a wireless module such that at least one vehicle connects to and transfers vehicle data to at least one different vehicle.

2. The device according to claim 1, wherein the device further comprises a Wireless Vehicle-to-Infrastructure Module, an Inertial Measurement Unit, a Global Navigation Satellite System or Global Positioning System Module, a Memory Storage Unit, a wireless communication module, an Inertial Module Unit, a wireless triangulation module, a plurality of antennas and an On-Board Diagnostics (OBD-II) port adapter.

3. The device according to claim 2, wherein the graphical user interface displays information from the at least one different vehicle collected through the device and accessed through software of an Application Programming Interface (API).

4. The device according to claim 1, wherein the device is mounted onto a dashboard of the at least one vehicle and provides Vehicle-to-Infrastructure (V2X) capabilities.

5. The device according to claim 1, wherein the device is built into an external housing, wherein the external housing is attached to a roof of the at least one vehicle.

6. The device according to claim 5, wherein the device uses inertial measurement units to calculate the vehicle data.

7. The device according to claim 1, wherein the device does not use an On-board Diagnostics Port of a vehicle to collect data and the device uses inertial measurement units to calculate the vehicle data.

8. The device according to claim 1, wherein the device collects data from the at least one different vehicle which is directly connected the device through an OBD-II port of the at least one vehicle.

9. The device according to claim 2, wherein a Pinger that pings a wireless network for available Vehicle-to-Infrastructure (V2X) capable devices and passes addresses of the available Vehicle-to-Infrastructure V2X capable devices to a local vehicle manager.

10. The device according to claim 2, wherein a module manager collects data from the device.

11. The device according to claim 3, wherein the API enables external access to latest data of the at least one different vehicle which is connected the at least one vehicle.

12. The device according to claim 11, wherein the API further enables external access to stored vehicle data and enables external access to data from all different devices which are connected to the device.

13. The device according to claim 2, wherein a local vehicle manager manages data from a Pinger; connects to all different devices connected to the device if found by the Pinger; disconnects from any of the different connected devices which have gone out of a wireless range; passes latest data from the at least one different vehicle to an Application Programming Interface (API); passes the latest data to all different devices which are connected to the device and passes data received from all the connected different devices to the API.

14. The device according to claim 13, wherein the connected different devices pass data collected from a receiver to the local vehicle manager and passes data from the at least one different vehicle to a transmitter and passes module data to the transmitter.

15. The device according to claim 14, wherein the receiver receives and parses data from V2X capable devices and passes data received from the V2X capable devices to the connected different devices.

16. The device according to claim 14, wherein the transmitter transmits data from the at least one different vehicle to V2X capable devices and transmits module data to the V2X capable devices.

17. The device according to claim 3, wherein the API allows third parties to manage data coming in through the device.

18. The device according to claim 3, wherein the API allows third parties to send custom commands to an OBD-II port of the at least one vehicle.

19. The device according to claim 1, wherein the device communicates wirelessly with any make or model of the at least one vehicle and an external device, which comprises a graphical user interface.

20. The device according to claim 3, wherein the API allows third parties to create accompanying web or phone applications that can access and manage connected vehicle data.
